(19) United States
(12) Patent Application Publication
(10) Pub. No.: US 2006/0281600 A1
(43) Pub. Date: Dec. 14, 2006

(54) Six-speed powertrain of automatic transmission for vehicle

(76) Inventor: Jong Sool Park, Suwon-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/151,162

(22) Filed: Jun. 10, 2005

(51) Int. Cl. F16H 3/62

(52) U.S. Cl. 475/275

(57) ABSTRACT

Shortened length, light weight, enhanced durability, and reduced power loss may be achieved when a powertrain of an automatic transmission is formed by combining one single pinion simple planetary gear set and two double pinion simple planetary gear sets. Two simple planetary gear sets are combined to form a compound planetary gear set having four operational elements by fixedly interconnecting two pairs of operating members therein such that the powertrain forms seven operational elements including one permanent input element, two selective input elements, one permanent fixed element, two selective fixed elements, one intermediate output element, and one permanent output element.

### FIELD OF THE INVENTION

The present invention relates to an automatic transmission, and more particularly, to a powertrain of an automatic transmission.

### BACKGROUND OF THE INVENTION

A multi-stage gearshift mechanism of an automatic transmission includes a plurality of planetary gear sets. A powertrain having such a plurality of planetary gear sets varies the torque in multi-stages and outputs it to an output shaft when receiving a converted engine torque from a torque converter.

The more speeds the powertrain of an automatic transmission has, the better the power performance and fuel consumption. Therefore, it is desirable for powertrains to have as many speeds as possible.

Even for the same number of speeds, durability, power transmission efficiency, and size/weight of a transmission are substantially dependent on how planetary gear sets are arranged. Therefore, research for more structural strength, less power loss, and more compact packaging are continuously being conducted.

Usually, development of a powertrain using planetary gear sets does not devise a wholly new type of planetary gear set. To the contrary, it invokes how single/double pinion planetary gear sets are combined, and how clutches, brakes, and one-way clutches are disposed to the combination of planetary gear sets such that required shift speeds and speed ratios are realized with minimal power loss.

For a manual transmission, too many speeds cause a driver the inconvenience of excessive manual shifting. However, for an automatic transmission, a transmission control unit automatically executes shifting by controlling the operation of the power train, and therefore, more speeds usually implies more merits.

Accordingly, research of four-speed and five-speed powertrains has been undertaken, and recently, a powertrain of an automatic transmission enabling six forward speeds and one reverse speed has been developed. An example of such research may be found in the powertrain of an automatic transmission disclosed in U.S. Pat. No. 6,071,208. However, such a conventional powertrain has drawbacks such as large volume and weight due to the use of as many as six frictional elements.

The above information disclosed in this Background section is only for enhancement of understanding of the background of the invention and therefore, it may contain information that does not form the prior art that is already known in this country to a person or ordinary skill in the art.

### SUMMARY OF THE INVENTION

Embodiments of the present invention provide a six-speed powertrain of an automatic transmission having advantages of shortened length and light weight by combining three planetary gear sets and five frictional elements.

According to an exemplary embodiment, the number of operating members rotating at high speed is reduced and slip speeds of frictional elements are reduced such that durability may be enhanced. Furthermore, durability is further enhanced and power loss is reduced by simplifying the power delivery path.

An exemplary six-speed powertrain of an automatic transmission according to an embodiment of the present invention is formed by combining a first planetary gear set of a simple planetary gear set with second and third planetary gear sets of double pinion simple planetary gear sets. The powertrain forms seven operational elements because it includes a compound planetary gear set formed as a combination of two planetary gear sets of the first, second, and third planetary gear sets, and two pairs of operating members of the two planetary gear sets being fixedly interconnected such that the compound planetary gear set forms four operational elements.

The seven operational elements include a first operational element always acting as a fixed element, a second operational element always rotating at a reduced speed, a third operational element always acting as an input element, a fourth operational element selectively acting as a fixed element or an input element receiving an output of the second operational element, a fifth operational element selectively acting as an input element or a fixed element, a sixth operational element always acting as an output element, and a seventh operational element selectively acting as an input element.

The compound planetary gear set may be formed as a combination of the first planetary gear set of a simple planetary gear set and the second planetary gear set of a double pinion simple planetary gear set.

The first, second, and third planetary gear sets may be sequentially arranged from an end of the powertrain.

The compound planetary gear set may be formed as a combination of the first and second planetary gear sets by fixedly interconnecting a first planet carrier of the first planetary gear set and a second planet carrier of the second planetary gear set, and by fixedly interconnecting a first ring gear of the first planetary gear set and a second ring gear of the second planetary gear set.

The first planetary gear set may include operating members of a first sun gear, a first ring gear, and a first planet carrier, the second planetary gear set may include operating members of a second sun gear, a second ring gear, and a second planet carrier, and the third planetary gear set may include operating members of a third sun gear, a third ring gear, and a third planet carrier. In this case, the first operational element may be formed by the third planet carrier, the second operational element may be formed by the third ring gear, the third operational element may be formed by the third sun gear, the fourth operational element may be formed by the second sun gear, the fifth operational element may be formed by the first and second ring gears wherein the first and second ring gears are fixedly interconnected, the sixth operational element may be formed by the first and second planet carriers wherein the first and second planet carriers are fixedly interconnected, and the seventh operational element may be formed by the first sun gear.

The first operational element may be fixedly connected to a transmission housing, the third operational element may be directly connected to an input shaft, the seventh operational element may be variably connected to the input shaft via a first clutch, the fifth operational element may be variably connected to the input shaft via a second clutch and also variably connected to the transmission housing via a first brake, and the fourth operational element may be variably connected to the second operational element via a third clutch and also variably connected to the transmission housing via a second brake.

The first and second clutches and the first brake may be disposed rearward in the transmission, and the third clutch and the second brake may be disposed forward in the transmission.

### BRIEF DESCRIPTION OF THE DRAWINGS

FIG. 1 is a schematic diagram of a powertrain of an automatic transmission according to an exemplary embodiment of the present invention.

FIG. 2 is an operational chart of a powertrain of an automatic transmission according to an exemplary embodiment of the present invention.

FIG. 3 is a shift diagram for first and second forward speeds of a powertrain of an automatic transmission according to an exemplary embodiment of the present invention.

FIG. 4 is a shift diagram for third and fourth forward speeds of a powertrain of an automatic transmission according to an exemplary embodiment of the present invention.

FIG. 5 is a shift diagram for fifth and sixth forward speeds and a reverse speed of a powertrain of an automatic transmission according to an exemplary embodiment of the present invention.

FIG. 6A shows exemplary gear ratios of a powertrain of an automatic transmission according to an exemplary embodiment of the present invention.

FIG. 6B shows exemplary gear ratios of a conventional powertrain of an automatic transmission.

FIG. 7A shows rotation speeds of respective operating members in a powertrain of an automatic transmission according to an exemplary embodiment of the present invention.

FIG. 7B shows rotation speeds of respective operating members in a conventional powertrain of an automatic transmission.

FIG. 8A shows slip speeds of non-operated frictional elements in a powertrain of an automatic transmission according to an exemplary embodiment of the present invention.

FIG. 8B shows slip speeds of non-operated frictional elements in a conventional powertrain of an automatic transmission.

FIG. 9A shows power delivery paths of a powertrain of an automatic transmission according to an exemplary embodiment of the present invention.

FIG. 9B shows power delivery paths of a conventional powertrain of an automatic transmission.

FIG. 10 is a schematic diagram of a conventional powertrain of an automatic transmission.

FIG. 11 is an operational chart of a powertrain of the automatic transmission shown in FIG. 10.

### DETAILED DESCRIPTION OF THE EMBODIMENTS

Embodiments of the present invention will hereinafter be described in detail with reference to the accompanying drawings.

As shown in FIG. 1, a powertrain of an automatic transmission according to an exemplary embodiment of the present invention includes first, second, and third planetary gear sets PG1, PG2, and PG3 arranged on an input shaft 100 connected to an engine output side via a torque converter.

The first planetary gear set PG1 is formed as a single pinion planetary gear set having operating members of a first sun gear S1, a first ring gear R1, and a first planet carrier PC1 rotatably supporting a pinion gear P1 engaged with the first sun gear S1 and the first ring gear R1.

The second planetary gear set PG2 is formed as a double pinion planetary gear set having operating members of a second sun gear S2, a second ring gear R2, and a second planet carrier PC2 rotatably supporting two pinion gears P2a and P2b engaged with the second sun gear S2 and the second ring gear R2.

The third planetary gear set PG3 is formed as a double pinion planetary gear set having operating members of a third sun gear S3, a third ring gear R3, and a third planet carrier PC3 rotatably supporting two pinion gears P3a and P3b engaged with the third sun gear S3 and the third ring gear R3.

The first, second, and third planetary gear sets PG1, PG2, and PG3 are arranged in the order of the third, second, and first planetary gear sets PG3, PG2, and PG1 from the engine. Among the operating members, the first and second planet carriers PC1 and PC2 and the first and second ring gears R1 and R2 are fixedly interconnected, respectively. According to such fixed interconnections of the first and second planet carriers PC1 and PC2 and the first and second ring gears R1 and R2, the first and second planetary gear sets PG1 and PG2 form one compound planetary gear set.

The third sun gear S3 is fixedly connected to the input shaft 100 so as to always act as an input element. The first sun gear S1 and the first ring gear R1 are variably connected to the input shaft 100 via first and second clutches C1 and C2 so as to variably act as input elements.

In addition, a connecting member 102 interconnecting the first and second ring gears R1 and R2 is variably connected to a transmission housing 104 via a first brake B1. The third planet carrier PC3 is fixedly connected to the housing 104 so as to always act as a fixed element. The second sun gear S2 and the third ring gear R3 are variably connected via a third clutch C3.

The second sun gear S2 is variably connected to the housing 104 via a second brake B2. The second planet carrier PC2 is provided with an output gear 106 so as to always act as an output element.

According to such an arrangement, the first and second clutches C1 and C2 and the first brake B1 are disposed rearward in the transmission, and the third clutch C3 and the second brake B2 are disposed forward in the transmission.

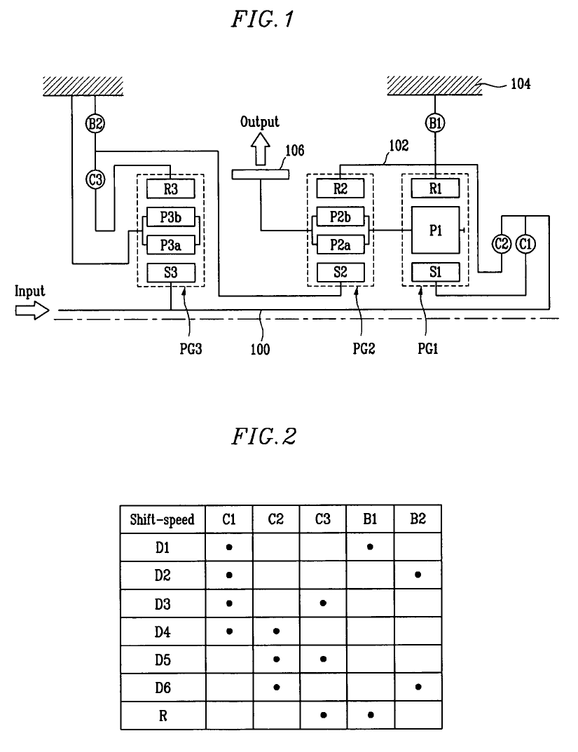

Such a powertrain may be operated according to an operational chart shown in FIG. 2 to realize six forward speeds and one reverse speed. That is, the first clutch C1 and the first brake B1 are operated for the first forward speed, the first clutch C1 and the second brake B2 are operated for the second forward speed, the first clutch C1 and the third clutch C3 are operated for the third forward speed, the first and second clutches C1 and C2 are operated for the fourth forward speed, the second and third clutches C2 and C3 are operated for the fifth forward speed, the second clutch C2 and the second brake B2 are operated for the sixth forward speed, and the third clutch C3 and the first brake B1 are operated for the reverse speed.

According to the powertrain of an exemplary embodiment of the present invention, one single pinion planetary gear set and two double pinion planetary gear sets are combined by fixedly connecting the first and second planet carriers PC1 and PC2 and the first and second ring gears R1 and R2 such that the powertrain may form seven operational elements as shown in FIG. 3.

Therefore, a first node N1 (hereinafter called a first operational element) is formed by the third planet carrier PC3. A second node N2 (hereinafter called a second operational element) is formed by the third ring gear R3. A third node N3 (hereinafter called a third operational element) is formed by the first sun gear S3. A fourth node N4 (hereinafter called a fourth operational element) is formed by the second sun gear S2. A fifth node N5 (hereinafter called a fifth operational element) is formed by the first and second ring gears R1 and R2. A sixth node N6 (hereinafter called a sixth operational element) is formed by the first and second planet carriers PC1 and PC2. A seventh node N7 (hereinafter called a seventh operational element) is formed by the first sun gear S1.

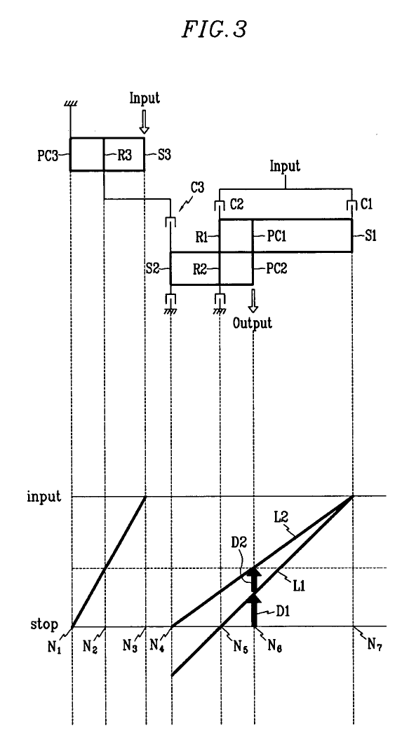

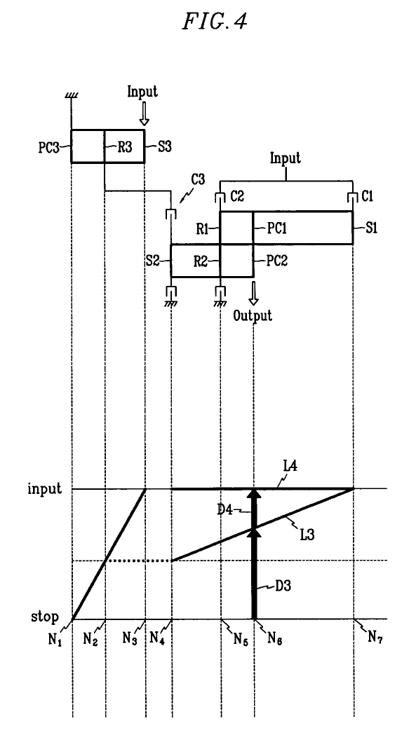

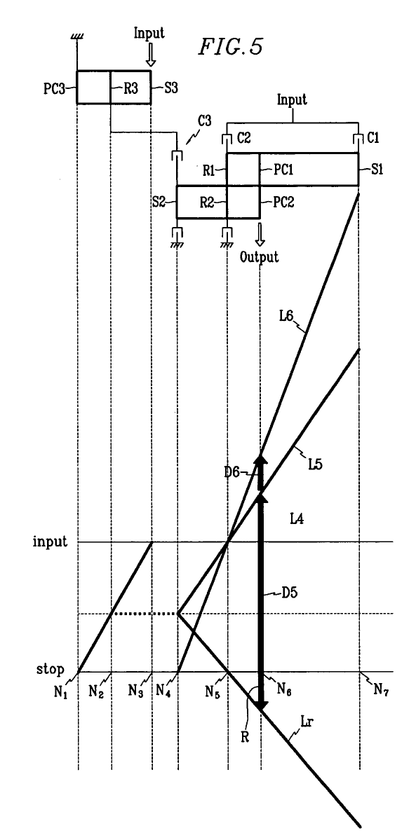

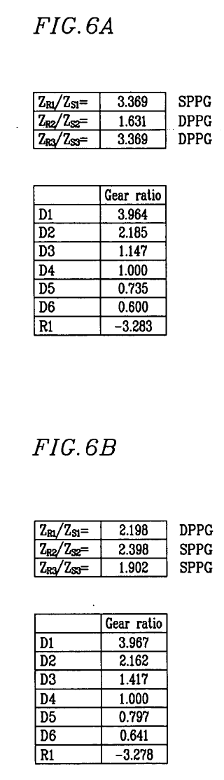

FIG. 3 to FIG. 5 show shift diagrams of a powertrain of an exemplary embodiment of the present invention in the case that gear ratios of respective planetary gear sets are predetermined as shown in FIG. 6A. Hereinafter, a shifting operation of the exemplary powertrain according to an embodiment of the present invention will be described in detail.

Firstly for the first forward speed, the first clutch C1 and the first brake B1 are operated.

Then, the seventh node N7 (i.e., the first sun gear S1) receives an input of an engine speed, and the fifth node N5 acts as a fixed element due to the operation of the first brake B1.

Therefore, a speed line of the first forward speed is formed as a speed line L connecting the seventh node N7, rotating at the engine speed, and the fifth node N5, remaining stationary. Therefore, the output element of the sixth node N6 rotates at a speed D1, and the first forward speed is realized.

In this case, the third planetary gear set PG3 does not take part in forming the first forward speed. That is, although the third sun gear S3 receives the input of the engine speed and the third planet carrier PC3 acts as the fixed element, the third ring gear R3 freely rotates since the third clutch C3 is disengaged.

For the second forward speed, the first brake B1 is released and the second brake B2 is operated from the first forward speed.

Then, the fixed element is changed to the second sun gear S2 (i.e., the fourth node N4), while the first sun gear S1 receives the input of the engine speed as in the first forward speed. Therefore, a speed line of the second forward speed is formed as a speed line L2 connecting the seventh node N7, rotating at the engine speed, and the fourth node N4, remaining stationary. Therefore, the output element of the sixth node N6 rotates at a speed D2, and the second forward speed is realized.

In this case, the third planetary gear set PG3 does not take part in forming the second forward speed, the same as in the first forward speed. That is, although the third sun gear S3 receives the input of the engine speed and the third planet carrier PC3 acts as the fixed element, the third ring gear R3 freely rotates since the third clutch C3 is disengaged.

For the third forward speed, the second brake B2 is released and the third clutch C3 is operated from the second forward speed.

Then, the third ring gear R3 and the second sun gear S2 are interconnected, while the first sun gear S1 remains receiving the input of the engine speed. In this case, the seventh node N7 receives an input of the engine speed, and the fourth node N4 receives a reduced speed that is reduced from the engine speed by the third planetary gear set PG3. Therefore, a speed line of the third forward speed is formed as a speed line L3 shown in FIG. 4. Therefore, the output element of the sixth node N6 rotates at a speed D3, and the third forward speed is realized.

For the fourth forward speed, the third clutch C3 is released and the second clutch C2 is operated from the third forward speed.

Then, the first sun gear S1 and the first ring gear R1 receive the input of the engine speed at the same time. Therefore, a speed line of the fourth forward speed is formed as a speed line L4, and the first and second planetary gear sets integrally rotate. Therefore, the output element of the sixth node N6 rotates at a speed D4 (i.e., at the same speed of the input engine speed), and the fourth forward speed is realized.

In this case, the third planetary gear set PG3 does not take part in forming the fourth forward speed, the same as in the first and second forward speeds. That is, although the third sun gear S3 receives the input of the engine speed and the third planet carrier PC3 acts as the fixed element, the third ring gear R3 freely rotates since the third clutch C3 is disengaged.

For the fifth forward speed, the first clutch C1 is released and the third clutch C3 is operated from the fourth forward speed.

Then, the third ring gear R3 and the second sun gear S2 are interconnected, while the first ring gear R1 remains receiving the input of the engine speed. In this case, the fifth node N5 receives an input of the engine speed, and the fourth node N4 receives a reduced speed that is reduced from the engine speed by the third planetary gear set PG3. Therefore, a speed line of the fifth forward speed is formed as a speed line L5 shown in FIG. 5. Therefore, the output element of the sixth node N6 rotates at a speed D5 faster than the input engine speed, and the fifth forward speed is realized.

For the sixth forward speed, the third clutch C3 is released and the second brake B2 is operated from the fifth forward speed.

Then, the second sun gear S2 acts as the fixed element, while the first ring gear R1 remains receiving the input of the engine speed. Therefore, a speed line of the sixth forward speed is formed as a speed line L6 connecting the fifth node N5, rotating at the engine speed, and the fourth node N4, remaining stationary. Therefore, the output element of the sixth node N6 rotates at a speed D6 faster than the input engine speed, and the sixth forward speed is realized.

In this case, the third planetary gear set PG3 does not take part in forming the sixth forward speed, the same as in the first, second, and fourth forward speeds. That is, although the third sun gear S3 receives the input of the engine speed and the third planet carrier PC3 acts as the fixed element, the third ring gear R3 freely rotates since the third clutch C3 is disengaged.

For the reverse speed, the third clutch C3 and the first brake B1 are operated.

Then, the third ring gear R3 and the second sun gear S2 are interconnected, while the fifth node N5 of the first and second ring gears R1 and R2 acts as the fixed element. Therefore, the fourth node N4 receives the reduced speed from the planetary gear set PG3. Therefore, a speed line of the reverse speed is formed as a speed line Lr connecting the fourth node N4, rotating at the reduced speed, and the fifth node N5, remaining stationary. Therefore, the output element of the sixth node N6 rotates at a speed R reversal to the input engine speed, and the reverse speed is realized.

FIGS. 6A and 6B, FIGS. 7A and 7B, FIGS. 8A and 8B, and FIGS. 9A and 9B compare operating states of a powertrain of an exemplary embodiment of the present invention and a conventional powertrain.

FIGS. 6A and 6B respectively show exemplary gear ratios of a powertrain of an exemplary embodiment of the present invention and a conventional power train. The gear ratios of a powertrain of an exemplary embodiment of the present invention have been prepared to show equivalent values to those of a conventional powertrain, for better comparison thereof.

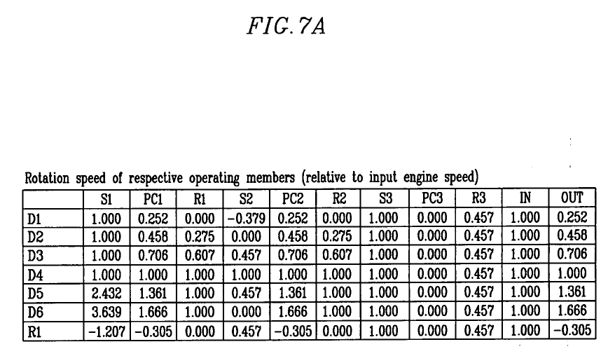

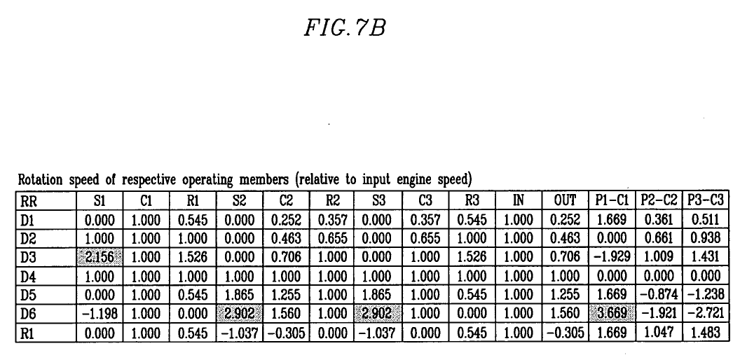

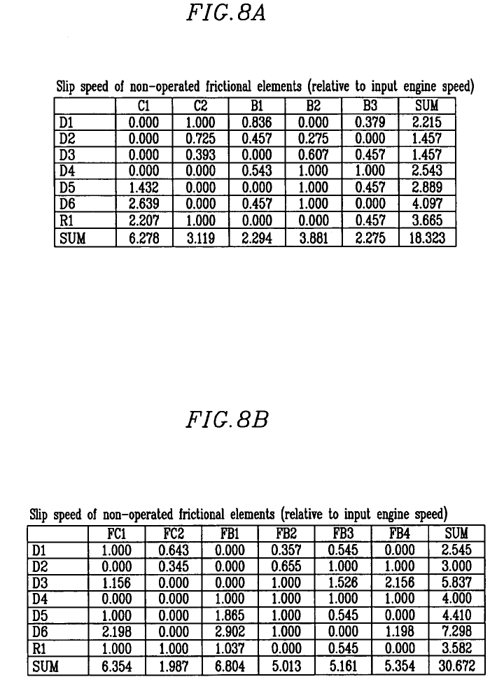

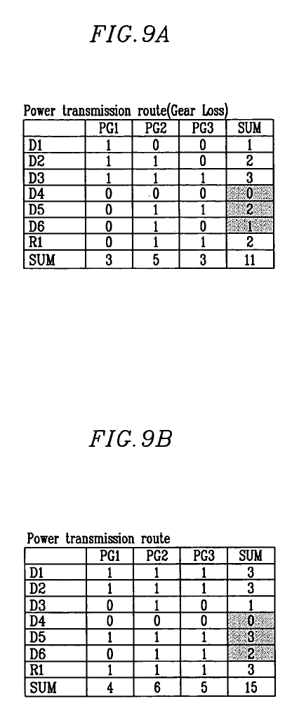

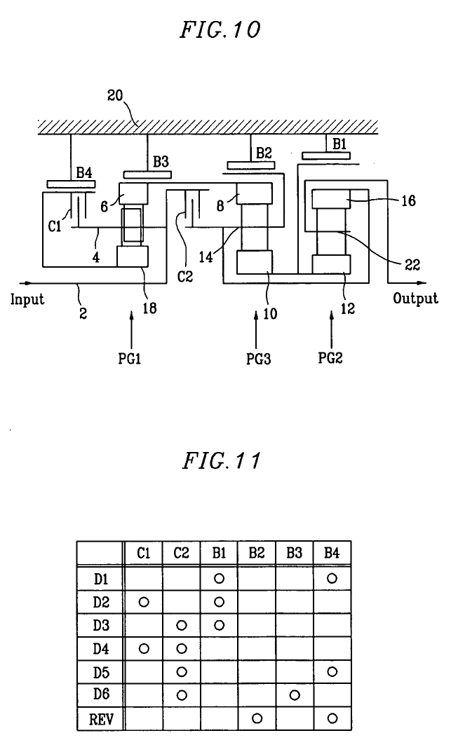

FIGS. 7A and 7B respectively show rotation speeds of respective operating members in a powertrain of an automatic transmission according to an exemplary embodiment of the present invention and in a conventional powertrain. FIGS. 8A and 8B respectively show slip speeds of non-operated frictional elements in a powertrain of an automatic transmission according to an exemplary embodiment of the present invention and in a conventional powertrain. FIGS. 9A and 9B respectively show power delivery paths of a powertrain of an automatic transmission according to an exemplary embodiment of the present invention and a conventional powertrain of an automatic transmission.

The numbers shown in FIGS. 6A to 8B may be obviously calculated by a person of ordinary skill in the art, based on the structural features and operational charts of the powertrain of the exemplary embodiment and the conventional powertrain.

According to the powertrain of the exemplary embodiment of the present invention, no operational element rotates faster than the input shaft at the third speed that is frequently engaged for acceleration (refer to FIG. 7A), and therefore, slip speeds of friction elements not operated at the third speed are less than the rotation speed of the input shaft (refer to FIG. 8A).

When the numerals shown in FIG. 8A are compared with those in FIG. 8B, it is apparent that the powertrain of the present embodiment shows less slip speeds of friction elements overall at the forward speeds than the conventional powertrain.

It is well known that more planetary gear sets implies more loss of power during power transmission. When the numerals shown in FIG. 9A are compared with those in FIG. 9B, it is apparent that the powertrain of the present embodiment has less planetary gear sets involved in the power transmission at many of the shift-speeds and accordingly shows better power efficiency

According to an exemplary embodiment of the present invention, six forward speeds and one reverse speed are achieved with three planetary gear sets and a minimized number of friction elements such that an automatic transmission becomes light and compact.

Durability is increased due to reduction of rotation speeds of operational elements at a shift-speed frequently engaged for acceleration. A further increase of durability and reduction of power loss is also achieved by reduction of slip speeds of friction elements. A shortened route of power transmission also contributes to an increase of durability and reduction of power loss.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A six-speed powertrain of an automatic transmission formed by combining a first planetary gear set of a simple planetary gear set and second and third planetary gear sets of double pinion simple planetary gear sets, the powertrain forming seven operational elements, by comprising
a compound planetary gear set formed as a combination of two planetary gear sets of the first, second, and third planetary gear sets, two pairs of operating members of the two planetary gear sets being fixedly interconnected such that the compound planetary gear set forms four operational elements,
wherein the seven operational elements comprise:
a first operational element always acting as a fixed element;
a second operational element always rotating at a reduced speed;
a third operational element always acting as an input element;
a fourth operational element selectively acting as a fixed element or an input element receiving an output of the second operational element;
a fifth operational element selectively acting as an input element or a fixed element;
a sixth operational element always acting as an output element; and
a seventh operational element selectively acting as an input element.

2. The six-speed powertrain of claim 1, wherein the compound planetary gear set is formed as a combination of the first planetary gear set of a simple planetary gear set and the second planetary gear set of a double pinion simple planetary gear set.

3. The six-speed powertrain of claim 2, wherein the first, second, and third planetary gear sets are sequentially arranged from an end of the powertrain.

4. The six-speed powertrain of claim 1, wherein the compound planetary gear set is formed as a combination of the first and second planetary gear sets by:
fixedly interconnecting a first planet carrier of the first planetary gear set and a second planet carrier of the second planetary gear set; and
fixedly interconnecting a first ring gear of the first planetary gear set and a second ring gear of the second planetary gear set.

5. The six-speed powertrain of claim 1, wherein;
the first planetary gear set comprises operating members of a first sun gear, a first ring gear, and a first planet carrier;
the second planetary gear set comprises operating members of a second sun gear, a second ring gear, and a second planet carrier;
the third planetary gear set comprises operating members of a third sun gear, a third ring gear, and a third planet carrier;
the first operational element is formed by the third planet carrier;
the second operational element is formed by the third ring gear;
the third operational element is formed by the third sun gear;
the fourth operational element is formed by the second sun gear;
the fifth operational element is formed by the first and second ring gears, the first and second ring gears being fixedly interconnected;
the sixth operational element is formed by the first and second planet carriers, the first and second planet carriers being fixedly interconnected; and
the seventh operational element is formed by the first sun gear.

6. The six-speed powertrain of claim 1, wherein:
the first operational element is fixedly connected to a transmission housing;
the third operational element is directly connected to an input shaft;
the seventh operational element is variably connected to the input shaft via a first clutch;
the fifth operational element is variably connected to the input shaft via a second clutch and also variably connected to the transmission housing via a first brake; and
the fourth operational element is variably connected to the second operational element via a third clutch and also variably connected to the transmission housing via a second brake.

7. The six-speed powertrain of claim 5, wherein:
the first operational element is fixedly connected to a transmission housing;
the third operational element is directly connected to an input shaft;
the seventh operational element is variably connected to the input shaft via a first clutch;
the fifth operational element is variably connected to the input shaft via a second clutch and also variably connected to the transmission housing via a first brake; and
the fourth operational element is variably connected to the second operational element via a third clutch and also variably connected to the transmission housing via a second brake.

8. The six-speed powertrain of claim 6, wherein:
the first and second clutches and the first brake are disposed rearward in the transmission; and
the third clutch and the second brake are disposed forward in the transmission.

9. The six-speed powertrain of claim 7, wherein:
the first and second clutches and the first brake are disposed rearward in the transmission; and
the third clutch and the second brake are disposed forward in the transmission.

10. A six-speed powertrain of an automatic transmission formed by combining first, second, and third planetary gear sets, the first planetary gear set being a single pinion planetary gear set having a first sun gear, a first ring gear, and a first planet carrier, the second planetary gear set being a double pinion planetary gear set having a second sun gear, a second ring gear, and a second planet carrier, and the third planetary gear set being a double pinion planetary gear set having a third sun gear, a third ring gear, and a third planet carrier, wherein:
the first and second planet carriers are fixedly interconnected;
the first and second ring gears are fixedly interconnected;
the third ring gear and the second sun gear are variably interconnected;
the third sun gear is directly connected to an input shaft;
the third planet carrier is directly connected to a transmission housing;
the second sun gear is connected to the transmission housing interposing a second brake;
the first sun gear and the first ring gear are respectively connected to the input shaft interposing first and second clutches; and
the first ring gear is connected to the transmission housing interposing a first brake.

11. A six-speed powertrain compound planetary gear set for an automatic transmission, comprising:
a first planetary gear set including a simple planetary gear set and two double pinion simple planetary gear sets;
a second planetary gear set including another simple planetary gear stet and two other double pinion simple planetary gear sets, wherein two pairs of operating members of said first and second planetary gear sets are fixedly interconnected;
a first operational element acting as a fixed element;
a second operational element rotating at a reduced speed;
a third operation element acting as an input element;
a fourth operational element selectively acting as a fixed element or an input element receiving an output from the second operational element;
a fifth operational element selectively acting as an input element or a fixed element;
a sixth operation element acting as an output element; and
a seventh operational element selectively acting as an input element.

12. The six-speed powertrain of claim 11, wherein said fixedly interconnected pairs of operating members form four operational elements.

13. The six-speed powertrain of claim 12, wherein the simple planetary gear set of said first planetary gear set is combined with one of the double pinion simple planetary gear sets of said second planetary gear set.

14. The six-speed powertrain of claim 12, wherein:
a first planet carrier of said first planetary gear set is fixedly interconnected with a second planet carrier of said second planetary gear set; and
a first ring gear of said first planetary gear set is fixedly interconnected with a second ring gear of said second planetary gear set.
